(19) United States
(12) Patent Application Publication
(10) Pub. No.: US 2026/0302039 A1
(43) Pub. Date: Oct. 1, 2026

(54) WINDING STRUCTURE

(71) Applicant: Delta Electronics, Inc., Taoyuan City (TW)

(72) Inventors: Yi-Jia CHEN, Taoyuan City (TW); Fan-Lin LIU, Taoyuan City (TW); Huai-Pei TUNG, Taoyuan City (TW); Kao-Tsai LIAO, Taoyuan City (TW); Qingwen FENG, Taoyuan City (TW)

(21) Appl. No.: 19/233,545

(22) Filed: Jun. 10, 2025

(30) Foreign Application Priority Data
Apr. 1, 2025 (CN) 202510400694.6

(51) Int. Cl. H01F 27/22; H01F 27/32

(52) U.S. Cl. CPC H01F 27/22; H01F 27/325

(57) ABSTRACT

A winding structure includes a bobbin, a first coil and a second coil. The first preceding winding segment of the first coil winds from the first end of the bobbin to the middle portion, forming first preceding loops in contact with the winding surface of the bobbin. The second preceding winding segment of the second coil winds from the second end to the middle portion, forming second preceding loops in contact with the winding surface. The first link segment of the first coil and the second link segment of the second coil are crossed at the middle portion. The first following winding segment of the first coil winds from the middle portion to the second end, forming first following loops on the second preceding loops. The second following winding segment of the second coil winds to the first end, forming second following loops on the first preceding loops.

### CROSS REFERENCE TO RELATED APPLICATIONS

This Application claims priority of China Patent Application No. 202510400694.6, filed on Apr. 1, 2025, the entirety of which is incorporated by reference herein.

### BACKGROUND OF THE INVENTION

### Field of the Invention

The present invention relates to a winding structure, and, in particular, to a winding structure with stacked layers.

### Description of the Related Art

As technology advances, the power requirements of electronic components continue to increase, and miniaturization is steadily progressing—resulting in increased heat density within the components. However, in components such as transformers and inductors, the high temperatures generated in the coils would limit the power increase.

The current winding structures dissipate the heat by means of glue or cold plates. However, due to the limitations of the winding structures, the gel used for heat dissipation cannot infiltrate into the coil, and the heat accumulated inside the coil cannot be transferred outward to the cold plate on the outside, making it difficult for the accumulated heat to be discharged and causing the temperature to rise. This causes thermal aging and cracking damage to the components and limits the increase in power density.

Therefore, to solve the heat dissipation problem, an improved winding structure is needed.

### BRIEF SUMMARY OF THE INVENTION

According to some embodiments of the present disclosure, a winding structure includes a bobbin, a first coil, and a second coil. The bobbin has a first end, a second end that is opposite to the first end, and a middle portion that is located between the first end and the second end. The first coil has a first preceding winding segment, a first following winding segment, and a first link segment that connects the first preceding winding segment and the first following winding segment. The second coil has a second preceding winding segment, a second following winding segment, a second link segment that connects the second preceding winding segment and the second following winding segment. The first preceding winding segment starts winding from the first end of the bobbin to the middle portion along an axial direction of the bobbin, so that the first preceding winding segment has a plurality of first preceding loops that are in contact with a winding surface of the bobbin. The second preceding winding segment starts winding from the second end of the bobbin to the middle portion along the axial direction of the bobbin, so that the second preceding winding segment has a plurality of second preceding loops that are in contact with the winding surface of the bobbin. The first link segment and the second link segment are crossed at the middle portion. The first following winding segment winds from the middle portion to the second end along the axial direction of the bobbin, so that the first following winding segment has a plurality of first following loops that wind on the second preceding loops. The second following winding segment winds from the middle portion to the first end along the axial direction of the bobbin, so that the second following winding segment has a plurality of second following loops that wind on the first preceding loops.

In some embodiments, the first coil and the second coil are made of the same wire.

In some embodiments, the first coil and the second coil are made of different wires.

In some embodiments, the bobbin further has a third end and a second middle portion that is located between the third end and the second end. The first coil further has a first additional winding segment and a first additional link segment that connects the first additional winding segment and the first following winding segment. The second coil further has a second additional winding segment and a second additional link segment that connects the second additional winding segment and the second preceding winding segment. The first additional link segment and the second additional link segment are crossed at the second middle portion. The first additional winding segment winds from the second middle portion to the third end along the axial direction of the bobbin, so that the first additional winding segment has a plurality of first additional loops that are in contact with winding surface of the bobbin. The second additional winding segment winds from the second middle portion to the third end along the axial direction of the bobbin, so that the second additional winding segment has a plurality of second additional loops that wind on the first additional loops.

In some embodiments, the first coil has a plurality of the first preceding winding segments, a plurality of the first following winding segments, and a plurality of the first link segments that connect each of the first preceding winding segments and each of the first following winding segments. The second coil has a plurality of the second preceding winding segments, a plurality of the second following winding segments, and a plurality of the second link segments that connect each of the second preceding winding segments and each of the second following winding segments. Along the axial direction of the bobbin, the first preceding loops, the second preceding loops, the first following loops, and the second following loops are formed in such a way that one of the second preceding loops is arranged between every two first preceding loops and one of the second following loops is arranged between every two first following loops.

In some embodiments, both the first coil and the second coil are bifilar coils.

In some embodiments, the two wires used in the first coil and the second coil are the same.

In some embodiments, both the first coil and the second coil are trifilar coils.

In some embodiments, the three wires used in the first coil and the second coil are the same.

In some embodiments, the first preceding loops and the second preceding loops form internal loops, and the first following loops and the second following loops form external loops. An intermediate winding is further included between the internal loops and the external loops. The intermediate winding is arranged parallel to the internal loops and the external loops.

In some embodiments, the first link segment and the second link segment are in contact with each other, and form a spacing between the first following loops and the second following loops.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A shows a cross-sectional perspective view of a conventional winding structure.

FIG. 1B shows a structural schematic view of the conventional winding structure.

FIG. 2A shows a cross-sectional perspective view of a winding structure, in accordance with some embodiments of the present disclosure.

FIG. 2B shows a structural schematic view of the winding structure, in accordance with some embodiments of the present disclosure.

FIG. 3 shows a cross-sectional perspective view of the winding structure, in accordance with some embodiments of the present disclosure.

FIG. 4 shows a comparison between the thermal resistances of the heat transmission paths of the conventional winding structure and the winding structure according to some embodiments of the present disclosure.

FIG. 5 shows a structural schematic view of the winding structure, in accordance with some embodiments of the present disclosure.

FIG. 6A shows a structural schematic view of the winding structure, in accordance with the first variation of the present disclosure.

FIG. 6B shows a structural schematic view of the winding structure, in accordance with the second variation of the present disclosure.

FIG. 7A shows a structural schematic view of the winding structure, in accordance with the third variation of the present disclosure.

FIG. 7B shows a structural schematic view of the winding structure, in accordance with the fourth variation of the present disclosure.

FIG. 7C shows a structural schematic view of the winding structure, in accordance with the fifth variation of the present disclosure.

FIG. 7D shows a partial enlargement of the winding structure shown in FIG. 7C.

FIG. 8 shows a structural schematic view of the winding structure, in accordance with the sixth variation of the present disclosure.

FIG. 9 shows a structural schematic view of the winding structure, in accordance with the seventh variation of the present disclosure.

FIG. 10 shows a structural schematic view of the winding structure, in accordance with the eighth variation of the present disclosure.

FIG. 11 shows a comparison between the simulation results of the conventional winding structure and the winding structure according to some embodiments of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact.

In addition, the present disclosure may repeat reference numerals and/or letters in the various embodiments. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are formed in direct contact, and may also include embodiments in which additional features may be formed interposing the features, such that the features may not be in direct contact.

In addition, spatially relative terms, for example, “vertical,” “above,” “over,” “below,”, “bottom,” etc. as well as derivatives thereof (e.g., “downwardly,” “upwardly,” etc.) are used for ease of the present disclosure of one feature relationship to another feature. The spatially relative terms are intended to cover different orientations of the device including the features.

The purpose of the embodiments of the present disclosure is to provide a winding structure that includes multiple layers of coils with improved cooling capacity. In addition to improving the heat dissipation efficiency of the winding structure itself, it also allows the medium that helps dissipate heat, such as gel, packaging material, and air, to enter into the winding structure and further conduct the heat accumulated inside out.

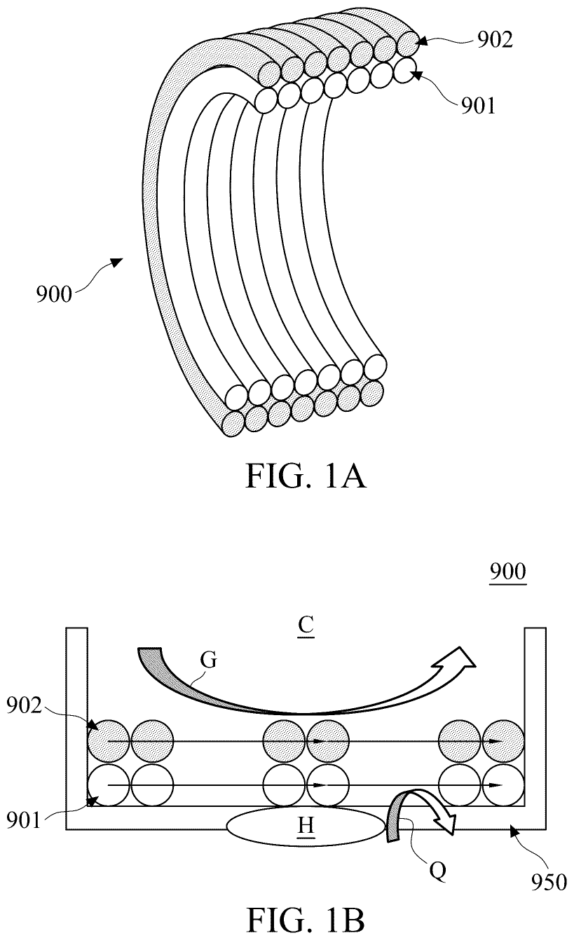

First, the structure of conventional winding structures is described with reference to FIG. 1A and FIG. 1B. FIG. 1A shows a cross-sectional perspective view of a conventional winding structure 900. FIG. 1B shows a structural schematic view of the conventional winding structure 900.

As an illustrative example, the winding structure 900 shown in FIG. 1A and FIG. 1B has two layers of coils: internal loops 901 and external loops 902. As shown in the figures, the internal loops 901 and the external loops 902 are arranged in parallel and disposed on a bobbin 950. The lower side of FIG. 1B is set as the heating side H, and the upper side is set as the cooling side C. Additionally, the arrow Q indicates the direction of heat transfer from the heating side H. The arrow G indicates the direction of distribution of the medium for heat dissipation (e.g. gel, packaging material, air, etc.) that is applied onto the winding structure 900.

As shown in FIG. 1B, the coils that form the internal loops 901 are linearly wound in the same plane, and the coils that form the external loops 902 are linearly wound in the same plane. The internal loops 901 are disposed on the side close to the heating side H, and the external loops 902 are disposed on the side close to the cooling side C.

In such winding structure 900, the heat from the heating side H is blocked by the internal loops 901 (as shown by arrow Q) and tends to accumulate inside the winding structure 900, making it difficult to transfer heat to the cooling side C. On the other hand, the medium used to assist in heat dissipation is also blocked by the external loops 902 (as shown by arrow G), and stays outside of the winding structure 900, making it impossible to efficiently dissipate heat that accumulates inside. Furthermore, there is often an air pocket between the internal loops 901 and the external loops 902, further blocking heat transfer.

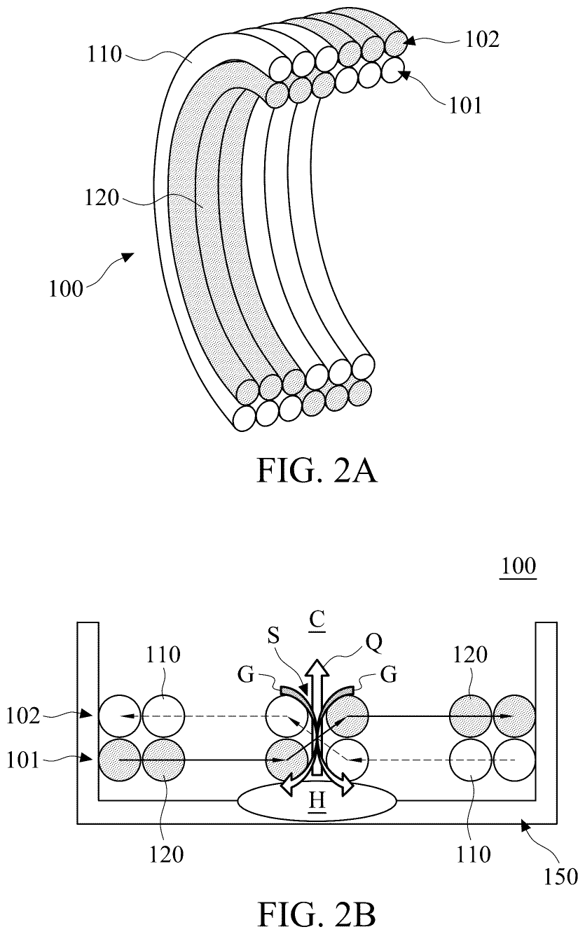

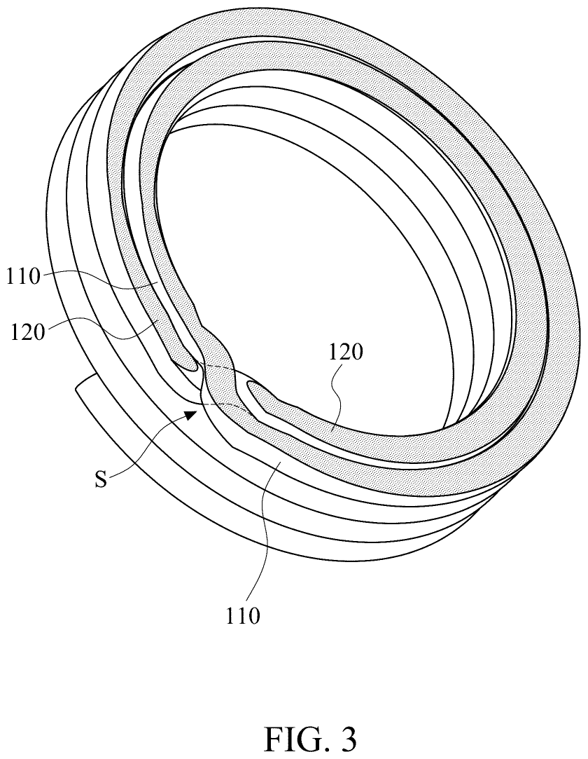

To solve this problem, the present disclosure provides a different winding structure. The winding structure of the present disclosure is described with reference to FIG. 2A, FIG. 2B, and FIG. 3. FIG. 2A shows a cross-sectional perspective view of a winding structure 100, in accordance with some embodiments of the present disclosure. FIG. 2B shows a structural schematic view of the winding structure 100, in accordance with some embodiments of the present disclosure. FIG. 3 shows a cross-sectional perspective view of the winding structure 100, in accordance with some embodiments of the present disclosure, wherein the bobbin 150 is omitted.

As an illustrative example, similar to the example shown in FIG. 1A and FIG. 1B, the winding structure 100 has two layers of coils: internal loops 101 and external loops 102. As shown in the figures, the internal loops 101 and the external loops 102 are arranged in parallel and disposed on a bobbin 150. Similar to FIG. 1B, the lower side of FIG. 2B is set as the heating side H, and the upper side is set as the cooling side C. Additionally, the arrow Q indicates the direction of heat transfer from the heating side H. The arrow G indicates the direction of distribution of the medium for heat dissipation (e.g. gel, packaging material, air, etc.) that is applied onto the winding structure 100.

What differs from the winding structure 900 is that, the internal loops 101 and the external loops 102 of the winding structure 100 are not respectively formed by a single coil. As shown in FIG. 2B, the winding structure 100 includes a first coil 110 and a second coil 120. In the embodiment shown in FIG. 2B, in the middle part of the winding structure 100, the first coil 110 and the second coil 120 have an up-and-down staggered structure, so that the inner and outer positions of the coils are interchanged. Thus, an interconnected structure is formed between the internal loops 101 and the external loops 102.

In such winding structure 100, a spacing S is formed at where the coils stagger, so that the heat from the heating side H is easily transferred to the cooling side C through the spacing S (as shown by arrow Q), and the medium for heat dissipation applied from the cooling side C can enter the winding structure 100 through the spacing S (as shown by arrow G). This helps to discharge accumulated internal heat and promote heat conduction.

As shown in FIG. 3, the spacing S is formed at where the first coil 110 and the second coil 120 stagger. The forming location of the spacing S can depend on user's needs. For example, the spacing S can be formed where the heat is most concentrated or close to the heat source to optimize heat dissipation. Additionally, the number of the spacing S is not limited to one. For example, the first coil 110 and the second coil 120 may stagger multiple times to create multiple spacings S to further improve cooling efficiency and make it easy to correspond to multiple heat sources.

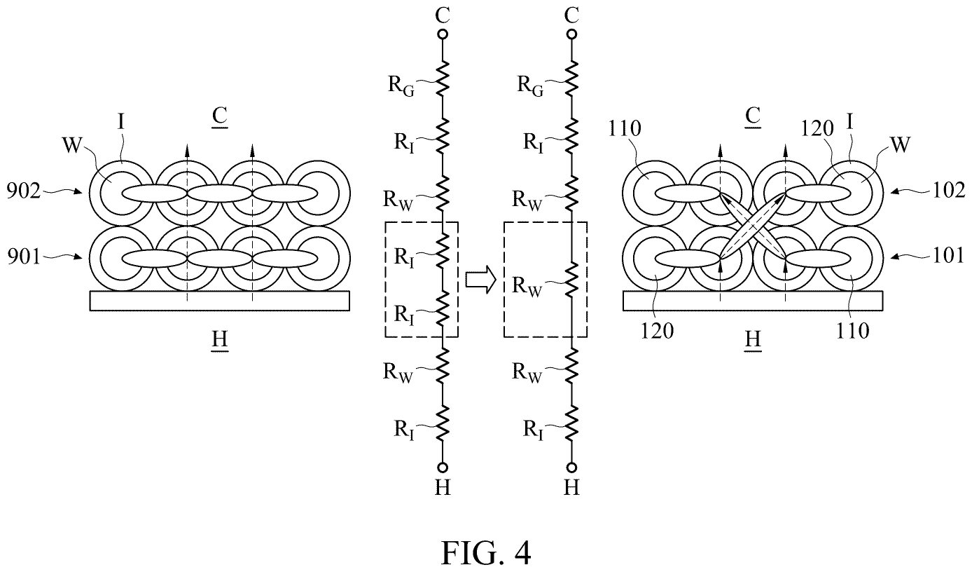

In addition to promoting heat conduction between the heating side H and the cooling side C by creating the spacing S, the winding structure 100 according to the presently disclosed embodiment has a heat dissipation efficiency itself that is superior to that of the previous winding structure 900. Referring to FIG. 4, it illustrates a comparison of the thermal resistances along the heat transmission paths between the conventional winding structure 900 and the winding structure 100 according to some embodiments of the present disclosure.

In general, the wires that form a coil may include a copper wire W and an insulating layer I that wraps the copper wire W. The copper wire W has good thermal conductivity, while insulating layer I usually has poor thermal conductivity.

The left side of FIG. 4 shows the heat transmission path of the conventional winding structure 900, and the right side shows the heat transmission path of the winding structure 100 according to embodiments of the present disclosure. As shown by the vertical arrow on the left, starting from the heating side H to the cooling side C, the heat transmission path of the winding structure 900 is: the insulating layer I of the internal loops 901 (R_{I} indicates the thermal resistance of the insulating layer I in FIG. 4), the copper wire W of the internal loops 901 (R_{W} indicates the thermal resistance of the copper wire W in FIG. 4), the insulating layer I on the other side of the internal loops 901, the insulating layer I of the external loops 902, the copper wire W of the external loops 902, the insulating layer I on the other side of the external loops 902, and medium for heat dissipation (R_{G} indicates the thermal resistance of the medium for heat dissipation in FIG. 4).

On the other hand, as shown by the vertical arrow on the right, starting from the heating side H to the cooling side C, the heat transmission path of the winding structure 100 is: the insulating layer I of the internal loops 101, the copper wire W of the internal loops 101, the copper wire W of the staggered portion, the copper wire W of the external loops 102, the insulating layer I on the other side of the external loops 102, and medium for heat dissipation.

Due to the staggered structure of the first coil 110 and the second coil 120 of the winding structure 100, when transferring heat from the internal loops 101 to the external loops 102, the heat can be conducted by interconnected copper wires W without pass through two insulating layers I as in the winding structure 900.

Therefore, by utilizing the winding structure 100, which is staggered up and down in the vertical direction, the heat conductivity in the vertical direction can be increased, and the heat (or loss) of the internal coils can be directed out quickly, reducing the maximum temperature inside. In this way, heat aging, heat cracking, and heat stress damage to the material can be reduced.

Moreover, because of the enhanced thermal conductivity of the winding structure 100, more layers of coils can be stacked for the same volume than in a conventional design, resulting in an increase in current density and an increase in power density. It also has the advantage of reduced size and cost for the same winding requirements.

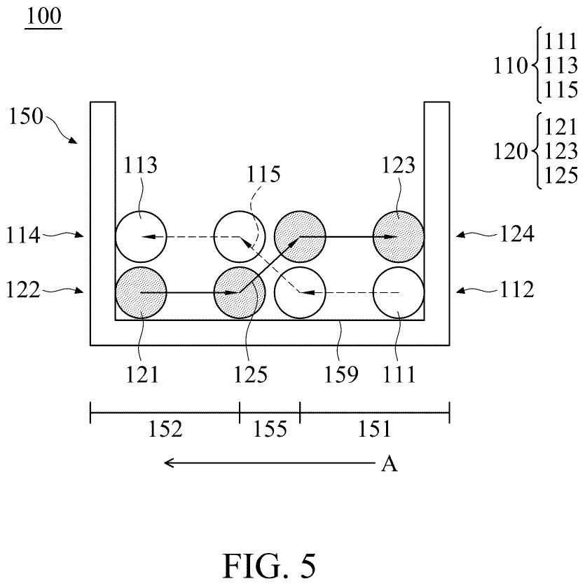

Next, the detailed structure of the winding structure 100 is described with reference to FIG. 5. FIG. 5 shows a structural schematic view of the winding structure 100, in accordance with some embodiments of the present disclosure.

According to some embodiments of the present disclosure, the winding structure 100 may include a bobbin 150, a first coil 110, and a second coil 120.

The bobbin 150 has a first end 151, a second end 152 that is opposite to the first end 151, and a middle portion 155 that is located between the first end 151 and the second end 152. In FIG. 5, the first end 151 is set on the right side of the figure, and the second end 152 is set on the left side of the figure.

The first coil 110 includes a first preceding winding segment 111, a first following winding segment 113, and a first link segment that connects the first preceding winding segment 111 and the first following winding segment 113. The second coil 120 includes a second preceding winding segment 121, a second following winding segment 123, and a second link segment that connects the second preceding winding segment 121 and the second following winding segment 123.

The first preceding winding segment 111 of the first coil 110 starts winding from the first end 151 to the middle portion 155 along the axial direction A of the bobbin 150, so that the first preceding winding segment 111 has a plurality of first preceding loops 112. In FIG. 5, in order to simply present the structure of the winding structure 100, only the two right-most and left-most first preceding loops 112 of the first preceding loops 112 are shown, and an unlimited number of first preceding loops 112 in the middle are omitted. Also, other loops and all loops in the following drawings are displayed in a similar manner. As shown in FIG. 5, all of the first preceding loops 112 are in contact with the winding surface 159 of the bobbin 150, being formed in the inner layer of the winding structure 100.

The second preceding winding segment 121 of the second coil 120 starts winding from the second end 152 to the middle portion 155 along the axial direction A of the bobbin 150, so that the second preceding winding segment 121 has a plurality of second preceding loops 122. As shown in FIG. 5, all of the second preceding loops 122 are in contact with the winding surface 159 of the bobbin 150, being formed in the inner layer of the winding structure 100.

The first link segment 115 of the first coil 110 and the second link segment 125 of the second coil 120 are crossed at the middle portion 155. For example, in the embodiment shown in FIG. 5, the first link segment 115 extends from the first preceding loops 112 in the inner layer toward the upper left side into the outer layer, and the second link segment 125 extends from the second preceding loops 122 in the inner layer toward the upper right side into the outer layer. In some embodiments, the first link segment 115 and the second link segment 125 are in contact with each other, and a spacing S (see FIG. 2B and FIG. 3) is formed at the intersection (e.g. between the first following loops 114 and the second following loops that will be described below).

The first following winding segment 113 of the first coil 110 winds from the middle portion 155 to the second end 152 along the axial direction A, so that the first following winding segment 113 has a plurality of first following loops 114. As shown in FIG. 5, the first following loops 114 wind on the second preceding loops 122, being formed in the outer layer of the winding structure 100.

The second following winding segment 123 of the second coil 120 winds from the middle portion 155 to the first end 151 along the axial direction A, so that the second following winding segment 123 has a plurality of second following loops 124. As shown in FIG. 5, the second following loops 124 wind on the first preceding loops 112, being formed in the outer layer of the winding structure 100.

As a result of the above winding method, the winding structure 100 according to the embodiment of the present disclosure is formed. Additionally, the forming location and numbers of the spacing S (that is, the intersection between the first coil 110 and the second coil 120) is not limited to the embodiment shown in FIG. 5, they can depend on user's needs. Also, the first coil 110 and the second coil 120 may have different variations. In the following paragraphs, various exemplary variations according to the present disclosure are described.

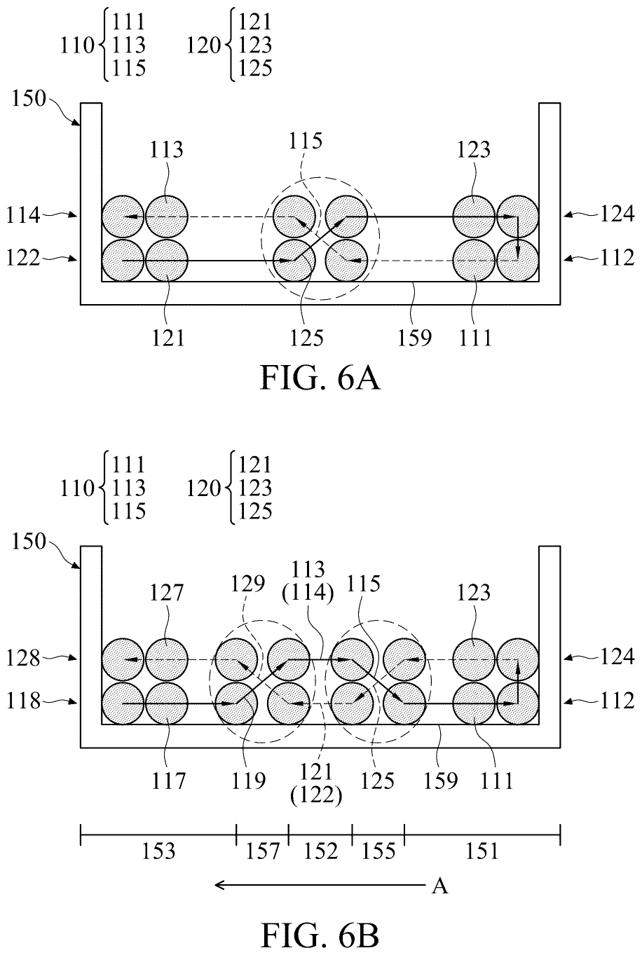

The first variation is described with reference to FIG. 6A. FIG. 6A shows a structural schematic view of the winding structure, in accordance with the first variation of the present disclosure. In FIG. 6A, the first coil 110 and the second coil 120 are made of the same wire. In other words, even if the winding structure consists of a single wire, the first coil 110 and the second coil 120 can be staggered in a vertical direction (perpendicular to the axial direction A).

The second variation is described with reference to FIG. 6B. FIG. 6B shows a structural schematic view of the winding structure, in accordance with the second variation of the present disclosure. In FIG. 6B, the first coil 110 and the second coil 120 are made of the same wire as well. Additionally, based on the winding structure 100 shown in FIG. 5, the winding structure extends further to the left side of the figure. In the present variation, the bobbin further includes a third end 153 and a second middle portion 157 that is located between the third end 153 and the second end 152.

The first coil 110 further include a first additional winding segment 117 and a first additional link segment 119 that connects the first additional winding segment 117 and the first following winding segment 113. The second coil 120 further include a second additional winding segment 127 and a second additional link segment 129 that connects the second additional winding segment 127 and the second preceding winding segment 121.

As shown in FIG. 6B, the first additional link segment 119 and the second additional link segment 129 are crossed at the second middle portion 157. For example, in the embodiment shown in FIG. 6B, the first additional link segment 119 extends from the first following loops 114 in the outer layer toward the lower left side into the inner layer, and the second additional link segment 129 extends from the second preceding loops 122 in the inner layer toward the upper left side into the outer layer. In some embodiments, the first additional link segment 119 and the second additional link segment 129 are in contact with each other, and a spacing S (see FIG. 2B and FIG. 3) is formed at the intersection.

The first additional winding segment 117 of the first coil 110 winds from the second middle portion 157 to the third end 153 along the axial direction A, so that the first additional winding segment 117 has a plurality of first additional loops 118. As shown in FIG. 6B, all of the first additional loops 118 are in contact with the winding surface 159 of the bobbin 150, being formed in the inner layer of the winding structure.

The second additional winding segment 127 of the second coil 120 winds from the second middle portion 157 to the third end 153 along the axial direction A, so that the second additional winding segment 127 has a plurality of second additional loops 128. As shown in FIG. 6B, all of the second additional loops 128 wind on the first additional loops 118, being formed in the outer layer of the winding structure.

By means of the above, the winding structure can be formed with multiple staggered structures (at the middle portion 155 and at the second middle portion 157) and with multiple spacings S. In this way, the heat exchange between the inner and outer layers of the winding structure can be promoted, and the efficiency of heat dissipation and cooling can be further enhanced.

In addition, the location of the middle portion 155 and the second middle portion 157 are not limited to the embodiment shown in FIG. 6B. The number of the first following loops 114 and the second preceding loops 122 on the second end 152 between the middle portion 155 and the second middle portion 157 may depend on actual needs. For example, the first following loops 114 may only include one loop that connects with the first link segment 115 and one loop that connects with the first link segment 119, so that the middle portion 155 and the second middle portion 157 are substantially adjacent to each other. Alternatively, the first following loops 114 may include more than two loops on the second end 152, so that the middle portion 155 and the second middle portion 157 are separated at a distance. The number of the second preceding loops 122 may be set in accordance to the number of the first following loops 114.

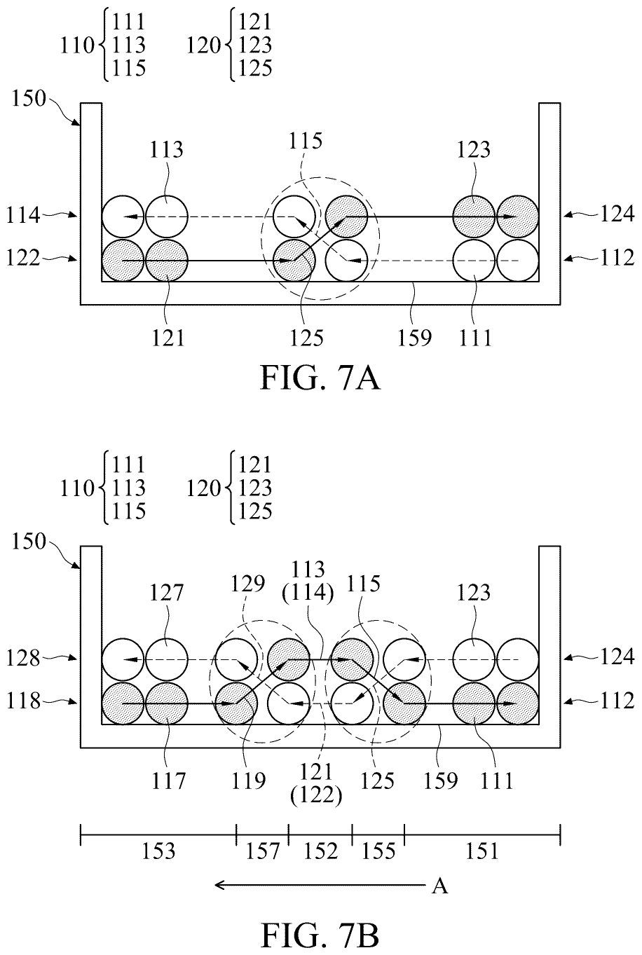

The third variation is described with reference to FIG. 7A. FIG. 7A shows a structural schematic view of the winding structure, in accordance with the third variation of the present disclosure. In FIG. 7A, the first coil 110 and the second coil 120 are made of different wires. In the present variation, for example, the first coil 110 and the second coil 120 may be used for different purposes.

The fourth variation is described with reference to FIG. 7B. FIG. 7B shows a structural schematic view of the winding structure, in accordance with the fourth variation of the present disclosure. The present variation is similar to the second variation described in accordance to FIG. 6B, the difference is that the first coil 110 and the second coil 120 of the present variation are made of different wires. Other similar structures are not repeated here.

The fifth variation is described with reference to FIG. 7C. FIG. 7C shows a structural schematic view of the winding structure, in accordance with the fifth variation of the present disclosure. In FIG. 7C, the first coil 110 and the second coil 120 are made of different wires. In the present variation, the first coil 110 includes a plurality of first preceding winding segments 111, a plurality of first following winding segments 113, and a plurality of first link segments 115 that connect each of the first preceding winding segments 111 and each of the first following winding segments 113. The second coil 120 includes a plurality of second preceding winding segments 121, a plurality of second following winding segments 123, and a plurality of second link segments 125 that connect each of the second preceding winding segments 121 and each of the second following winding segments 123. Each of the first preceding winding segments 111is wound as a first preceding loop 112. Each of the first following winding segments 113 is wound as first following loop 114. Each of the second preceding winding segments 121 is wound as a second preceding loop 122. Each of the second following winding segments 123 is wound as a second following loop 124.

As shown in FIG. 7C, along the axial direction A, the first preceding loops 112, the second preceding loops 122, the first following loops, 114 and the second following loops 124 are formed in such a way that one of the second preceding loops 122 is arranged between every two first preceding loops 112 and one of the second following loops 124 is arranged between every two first following loops 114.

In order to more clearly illustrate the winding structure of the fifth variation of the present disclosure, please refer to FIG. 7D. FIG. 7D shows a partial enlargement of the winding structure shown in FIG. 7C. In order to facilitate understanding, similar number references as those in FIG. 5 are used in FIG. 7D to indicate a similar structure.

As shown in FIG. 7D, along the axial direction A, the first preceding winding segment 111 of the first coil 110 starts winding from the first end 151 of the bobbin 150 to the middle portion 155, forming the first preceding loop 112. The second following loop 124 formed by the second following winding segment 123 of the second coil 120 winds on the first preceding loop 112 on the first end 151.

The first link segment 115 of the first coil 110 and the second link segment 125 of the second coil 120 are crossed at the middle portion 155, so that on the second end 152, the first following loop 114 formed by the first following winding segment 113 of the 110 winds on the second preceding loop 122 formed by the second preceding winding segment 121 of the second coil 120.

In the winding structure of the fifth variation, since one of the first link segments 115 is connected between each one of the first preceding winding segments 111 and each one of the first following winding segments 113, and similarly, one of the second link segments 125 is connected between each one of the second preceding winding segments 121 and each one of the second following winding segments 123, one middle portion 155 is further included between said second end 152 and the next first end 151. And, the first link segment 115 and the second link segment 125 are crossed again here.

By repeating said structure as shown in FIG. 7D, a staggered structure is arranged between each of the loops. That is, a spacing is formed between every loop. This promotes heat exchange between the inner and outer layers of the winding structure and improves heat dissipation efficiency. In addition, this staggered structure also enhances the degree of coupling between the two wires and improves the power conversion efficiency.

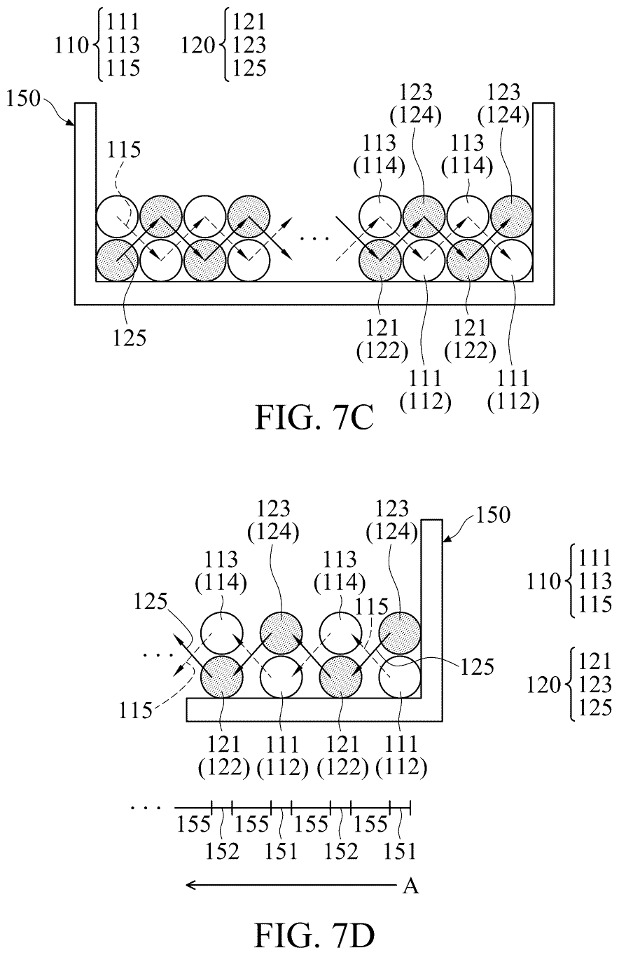

The sixth variation is described with reference to FIG. 8. FIG. 8 shows a structural schematic view of the winding structure, in accordance with the sixth variation of the present disclosure. In FIG. 8, both the first coil 110 and the second coil 120 are bifilar coils. In other words, both the first coil 110 and the second coil 120 are made of two wires. During the winding process, the two respective wires are wound together on the bobbin 150.

Although the first coil 110 and the second coil 120 are labeled in FIG. 8 using different filling methods, it does not mean that the first coil 110 and the second coil 120 must be different coils. For example, the first coil 110 and the second coil 120 may be wound with two wires in parallel using any of the first to fifth variations shown in FIG. 6A to FIG. 7C. In other words, the two wires used in the first coil 110 and the two wires used in the second coil 120 may be the same (e.g. the first and second variations). Alternatively, the two wires used in the first coil 110 and the two wires used in the second coil 120 may be different (e.g. the third to fifth variations). Additionally, the two wires in one single coil may be the same two wires or two different wires.

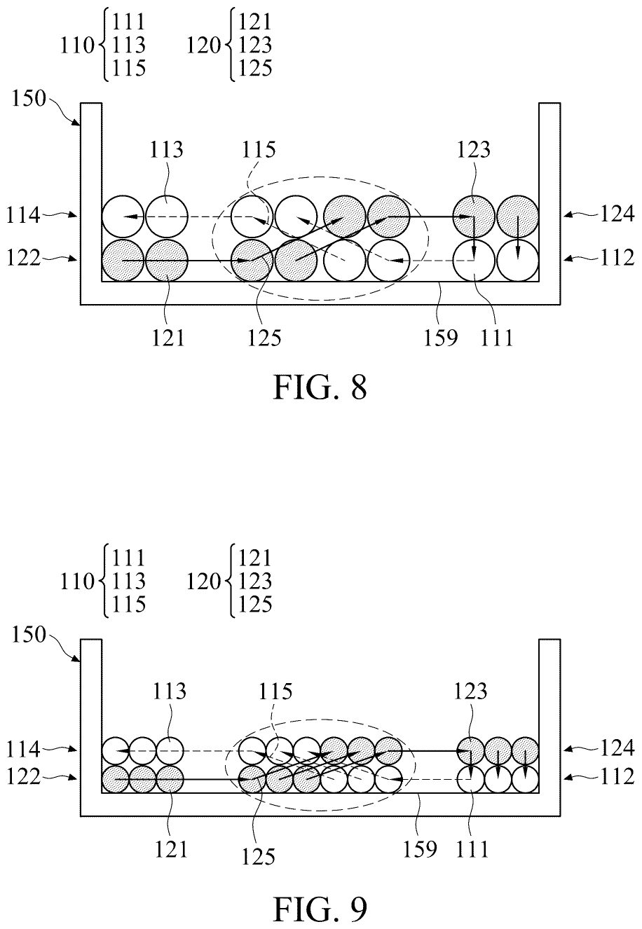

The seventh variation is described with reference to FIG. 9. FIG. 9 shows a structural schematic view of the winding structure, in accordance with the seventh variation of the present disclosure. In FIG. 9, both the first coil 110 and the second coil 120 are trifilar coils. In other words, both the first coil 110 and the second coil 120 are made of three wires. During the winding process, the three respective wires are wound together on the bobbin 150.

Although the first coil 110 and the second coil 120 are labeled in FIG. 9 using different filling methods, it does not mean that the first coil 110 and the second coil 120 must be different coils. For example, the first coil 110 and the second coil 120 may be wound with three wires in parallel using any of the first to fifth variations shown in FIG. 6A to FIG. 7C. In other words, the three wires used in the first coil 110 and the three wires used in the second coil 120 may be the same (e.g. the first and second variations). Alternatively, the three wires used in the first coil 110 and the three wires used in the second coil 120 may be different (e.g. the third to fifth variations). Additionally, the three wires in one single coil may be the same three wires or three different wires. The winding methods and coil types of the winding structures disclosed herein can be arbitrarily combined depending on the requirements.

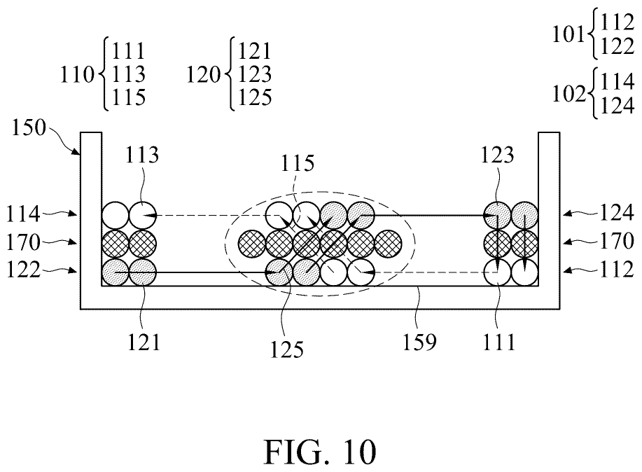

The eighth variation is described with reference to FIG. 10. FIG. 9 shows a structural schematic view of the winding structure, in accordance with the eighth variation of the present disclosure. The winding structure shown in FIG. 10 further includes an intermediate winding 170 that is disposed between the internal loops 101 that is formed by the first preceding loops 112 and the second preceding loops 122 and the external loops 102 that is formed by the second preceding loops 114 and the second following loops 124. As such, the internal loops 101 and the external loops 102 become a non-adjacent structure. As shown in FIG. 10, the intermediate winding 170 may be arranged parallel to the internal loops 101 and the external loops 102.

Depending on the user's needs, a suitable winding can be selected as the intermediate winding 170. For example, the intermediate winding 170 can have an insulating function. Alternatively, the intermediate winding 170 can be a third coil wound on the bobbin 150. Alternatively, the intermediate winding 170 may be a signal wire, which has the function of transmitting a signal.

Although the first coil 110 and the second coil 120 are labeled in FIG. 10 using different filling methods, and bifilar first coil 110 and second coil 120 are shown, it is not limiting. For example, the first coil 110 and the second coil 120 with an intermediate winding 170 in between may be wound using any of the first to seventh variations shown in FIG. 6A to FIG. 9. The winding methods and coil types of the winding structures disclosed herein can be arbitrarily combined depending on the requirements.

In the present disclosure, eight different variations are exemplarily illustrated utilizing FIG. 6A through FIG. 10. It should be understood that a winding structure that arbitrarily combines the various features contained in the various embodiments is also included within the scope of the present disclosure.

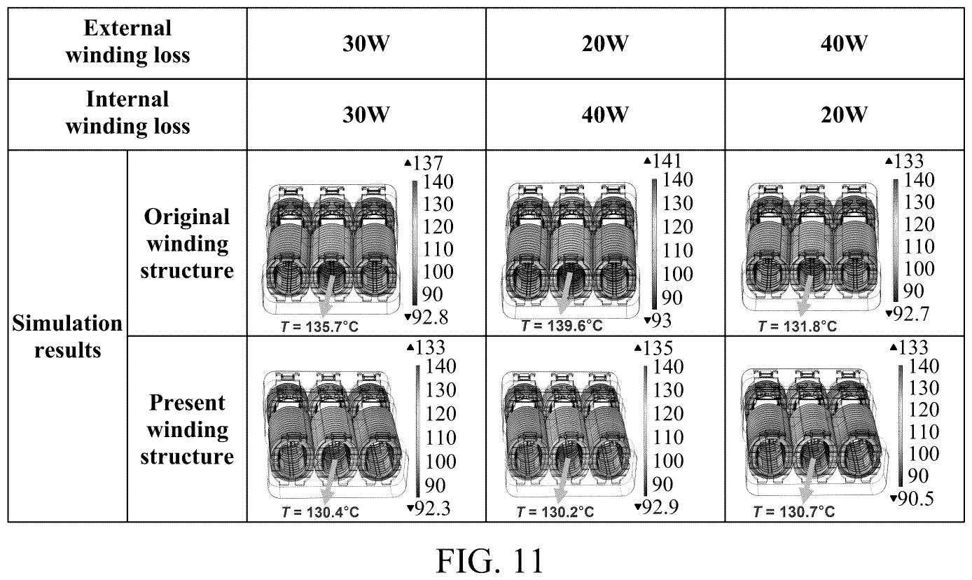

Next, a comparison of the respective simulation results of the conventional winding structure and the winding structure according to some embodiments of the present disclosure is illustrated with reference to FIG. 11. As shown in FIG. 11, in the original winding structure, the temperature measured in each winding structure varied depending on the external winding loss and the internal winding loss. As mentioned above, the heat accumulated in the inner layer of the original winding structure is more difficult to remove, and therefore, the highest temperature is measured when the internal winding loss is larger than the external winding loss (the original winding structure in the middle). On the contrary, when the external winding loss is larger than the internal winding loss, the measured temperature is relatively lower (the original winding structure on the right).

However, as shown in FIG. 11, regardless of the internal winding loss and the external winding loss, the winding structure of the present disclosure is able to dissipate the heat well, and achieve the effect of temperature reduction compared to the original winding structure. This is due to the fact that the winding structure according to the present disclosure establishes heat conduction paths for the inner and outer coils in the vertical direction, which reduces the thermal resistance between the inner and outer coils, and therefore reduces the heat accumulation in the inner layer and effectively lowers the temperature.

In summary, through the staggered structure of the first coil 110 and the second coil 120 in the vertical direction, an interconnecting structure is formed between the internal loops 101 and the external loops 102, and a spacing S is formed between the loops. As such, in addition to enhancing the heat dissipation efficiency of the winding structure itself, a medium that helps dissipate heat can have access into the interior of the winding structure to further conduct the heat accumulated inside outwardly. Therefore, the winding structure according to the present disclosure has significantly improved heat dissipation capability, which is advantageous for application in components with high heat density (such as inductors, transformers, and similar components.).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A winding structure, comprising:
a bobbin that has:
a first end;
a second end that is opposite to the first end; and
a middle portion, located between the first end and the second end;
a first coil that has:
a first preceding winding segment;
a first following winding segment; and
a first link segment that connects the first preceding winding segment and the first following winding segment;
a second coil that has:
a second preceding winding segment;
a second following winding segment; and
a second link segment that connects the second preceding winding segment and the second following winding segment;
wherein:
the first preceding winding segment starts winding from the first end of the bobbin to the middle portion along an axial direction of the bobbin, so that the first preceding winding segment has a plurality of first preceding loops that are in contact with a winding surface of the bobbin;
the second preceding winding segment starts winding from the second end of the bobbin to the middle portion along the axial direction of the bobbin, so that the second preceding winding segment has a plurality of second preceding loops that are in contact with the winding surface of the bobbin;
the first link segment and the second link segment are crossed at the middle portion;
the first following winding segment winds from the middle portion to the second end along the axial direction of the bobbin, so that the first following winding segment has a plurality of first following loops that wind on the second preceding loops; and
the second following winding segment winds from the middle portion to the first end along the axial direction of the bobbin, so that the second following winding segment has a plurality of second following loops that wind on the first preceding loops.

2. The winding structure as claimed in claim 1, wherein the first coil and the second coil are made of the same wire.

3. The winding structure as claimed in claim 2, wherein:
the bobbin further has a third end and a second middle portion that is located between the third end and the second end;
the first coil further has a first additional winding segment and a first additional link segment that connects the first additional winding segment and the first following winding segment;
the second coil further has a second additional winding segment and a second additional link segment that connects the second additional winding segment and the second preceding winding segment;
the first additional link segment and the second additional link segment are crossed at the second middle portion;
the first additional winding segment winds from the second middle portion to the third end along the axial direction of the bobbin, so that the first additional winding segment has a plurality of first additional loops that are in contact with winding surface of the bobbin; and
the second additional winding segment winds from the second middle portion to the third end along the axial direction of the bobbin, so that the second additional winding segment has a plurality of second additional loops that wind on the first additional loops.

4. The winding structure as claimed in claim 1, wherein the first coil and the second coil are made of different wires.

5. The winding structure as claimed in claim 4, wherein:
the bobbin further has a third end and a second middle portion that is located between the third end and the second end;
the first coil further has a first additional winding segment and a first additional link segment that connects the first additional winding segment and the first following winding segment;
the second coil further has a second additional winding segment and a second additional link segment that connects the second additional winding segment and the second preceding winding segment;
the first additional link segment and the second additional link segment are crossed at the second middle portion;
the first additional winding segment winds from the second middle portion to the third end along the axial direction of the bobbin, so that the first additional winding segment has a plurality of first additional loops that are in contact with winding surface of the bobbin; and
the second additional winding segment winds from the second middle portion to the third end along the axial direction of the bobbin, so that the second additional winding segment has a plurality of second additional loops that wind on the first additional loops.

6. The winding structure as claimed in claim 1, wherein:
the first coil has a plurality of the first preceding winding segments, a plurality of the first following winding segments, and a plurality of the first link segments that connect each of the first preceding winding segments and each of the first following winding segments;
the second coil has a plurality of the second preceding winding segments, a plurality of the second following winding segments, and a plurality of the second link segments that connect each of the second preceding winding segments and each of the second following winding segments; and
along the axial direction of the bobbin, the first preceding loops, the second preceding loops, the first following loops, and the second following loops are formed in such a way that one of the second preceding loops is arranged between every two first preceding loops and one of the second following loops is arranged between every two first following loops.

7. The winding structure as claimed in claim 1, wherein both the first coil and the second coil are bifilar coils.

8. The winding structure as claimed in claim 7, wherein the two wires used in the first coil and the second coil are the same.

9. The winding structure as claimed in claim 1, wherein both the first coil and the second coil are trifilar coils.

10. The winding structure as claimed in claim 9, wherein the three wires used in the first coil and the second coil are the same.

11. The winding structure as claimed in claim 1, wherein:
the first preceding loops and the second preceding loops form internal loops, and the first following loops and the second following loops form external loops;
an intermediate winding is further comprised between the internal loops and the external loops; and
the intermediate winding is arranged parallel to the internal loops and the external loops.

12. The winding structure as claimed in claim 1, wherein the first link segment and the second link segment are in contact with each other, and form a spacing between the first following loops and the second following loops.
